(19) United States
(12) Patent Application Publication
(10) Pub. No.: US 2024/0219924 A1
(43) Pub. Date: Jul. 4, 2024

(54) ROBOT CONTROL SYSTEM, ROBOT CONTROL METHOD, AND WIRELESS CALL DEVICE

(71) Applicant: B-ROBOTICS CO., LTD., Seoul (KR)

(72) Inventors: Myung Sik KIM, Suwon-si (KR); Ji Won LIM, Seoul (KR); Min Soo KIM, Seoul (KR)

(73) Assignee: B-ROBOTICS CO., LTD., Seoul (KR)

(21) Appl. No.: 17/913,836

(22) PCT Filed: Mar. 22, 2021
(86) PCT No.: PCT/KR2021/003507

§ 371 Date: Sep. 23, 2022

(30) Foreign Application Priority Data
Mar. 25, 2020 (KR) 10-2020-0036487
Mar. 15, 2021 (KR) 10-2021-0033119

(51) Int. Cl. G05D 1/646; G05D 1/622; G05D 105/20; G05D 111/30

(52) U.S. Cl. CPC G05D 1/646; G05D 1/622; G05D 2105/20; G05D 2111/34

(57) ABSTRACT

A robot control system installed in a robot so as to control the robot includes a control module for controlling the robot to move along a preconfigured autonomous traveling path in an autonomous traveling mode; a mode switching module for switching the robot from the autonomous traveling mode to a movement path reconfiguration mode when predetermined switching conditions are satisfied while the robot is in the autonomous traveling mode; and a configuration module for, when the robot is moved by an external force in the movement path reconfiguration mode, tracking a movement path while the robot is moved by the external force and reconfiguring the autonomous traveling path on the basis of the tracked movement path.

### CROSS REFERENCE TO RELATED APPLICATION

This application is a National Stage Entry of International Application No. PCT/KR2021/003507, filed on Mar. 22, 2021, and claims priority from and the benefit of Korean Patent Application Nos. 10-2020-0036487, filed on Mar. 25, 2020 and Korean Patent Application No. 10-2021-0033119, filed on Mar. 15, 2021, each of which is hereby incorporated by reference for all purposes as if fully set forth herein.

### BACKGROUND

### Field

Embodiments/implementations of the invention relate generally to a robot control system, a robot control method, and a wireless call device for calling a robot equipped with the robot control system. More particularly, the following description relates to a system and method for allowing a serving robot operated in a store to easily change a stop position or an autonomous traveling path thereof and allowing a user or a store employee to easily call the serving robot.

### Discussion of the Background

With development of autonomous driving and robot technology, research is being actively conducted to serve food in stores such as restaurants with a serving robot. The serving robot travels along a predetermined path in a store on behalf of a person, or recognizes obstacles on the traveling path, loads cooked food, and serves customers. Such a serving robot is mainly provided in a food service establishment (hereinafter referred to as a “store”) to perform predetermined functions. To this end, the serving robot creates a map including a moving route within the store, and the stop position and direction of the serving robot are specified in advance.

However, if the layout is changed or the position of tables is moved depending on circumstances of the store, a route along which the serving robot moves for serving or a position where the serving robot will stop is also changed, and there is a risk of causing a malfunction of the serving robot. Conventionally, in order to change the movement path or stop position of the serving robot, there has been only a way to re-designate it using a dedicated program or change it remotely through a service server. Accordingly, there is an issue in that it is difficult to quickly respond to the needs of the store, resulting in service disruption.

In addition, when a customer finishes eating and moves dishes to a tray return station or when a store clerk cleans the table after meals, loading empty dishes on the serving robot may improve convenience and safety compared to the conventional case where a person directly transports the dishes by hand. To this end, it is necessary to call the serving robot at a time desired by the customer or the clerk. According to a related art, there is an issue in that utilization of the serving robot is lowered due to insufficiency of such a call function.

Therefore, there is a need for a technical idea that allows a simple and easy change of a movement path or a stop position of the serving robot in the store.

Further, a technical idea is required to easily call a serving robot when desired in addition to serving food.

The above information disclosed in this Background section is only for understanding of the background of the inventive concepts, and, therefore, it may contain information that does not constitute prior art.

### SUMMARY

Embodiments of the present disclosure provide technical ideas that allow a simple and easy change of an autonomous traveling path or a stop position of a serving robot in a store.

In addition, embodiments of the present disclosure provide technical ideas that make it easy to call the serving robot when the serving robot is needed, including serving of food.

Additional features of the inventive concepts will be set forth in the description which follows, and in part will be apparent from the description, or may be learned by practice of the inventive concepts.

According to aspects, there is provided a robot control system installed in a robot to control the robot, including a control module configured to control the robot to move along a preconfigured autonomous traveling path in an autonomous traveling mode; a mode switching module configured to switch the robot from the autonomous traveling mode to a movement path reconfiguration mode when a predetermined switching condition is satisfied while the robot is in the autonomous traveling mode; and a configuration module configured to, when the robot is moved by an external force in the movement path reconfiguration mode, track a movement path while the robot is moved by the external force, and to reconfigure the autonomous traveling path based on the tracked movement path.

In an example embodiment, the mode switching module may be configured to switch the robot to the movement path reconfiguration mode when a movement path reconfiguration command is input through a predetermined input device installed in the robot while the robot is in the autonomous traveling mode.

In an example embodiment, the mode switching module may be configured to switch the robot to the movement path reconfiguration mode when the robot deviates from the autonomous traveling path by an external force a predetermined number of times or more or for a predetermined period of time or more while the robot is in the autonomous traveling mode.

In an example embodiment, the mode switching module may be configured to switch the robot to the movement path reconfiguration mode when the robot detects an obstacle that prevents movement while moving along the autonomous traveling path in the autonomous traveling mode.

In an example embodiment, the control module may be configured to control the robot to move to a preconfigured stop position when the robot is called in the autonomous traveling mode.

In an example embodiment, the control module may be configured to control the robot to move along the autonomous traveling path when a predetermined stop period of time elapses after the robot moves to the stop position, and extend the stop period of time when it is detected that the robot is loaded with an object.

According to other aspects, there is provided a robot control system installed in a robot to control the robot including a control module configured to control the robot to move to a preconfigured stop position when the robot is called in an autonomous traveling mode; a mode switching module configured to switch the robot from the autonomous traveling mode to a stop position reconfiguration mode when a predetermined switching condition is satisfied while the robot is in the autonomous traveling mode; and a configuration module configured to, when the robot is moved by an external force in the stop position reconfiguration mode, determine a movement position to which the robot is moved by an external force, and reconfigure the stop position to the movement position.

In an example embodiment, the mode switching module may be configured to, when a stop position reconfiguration command is input through a predetermined input device installed in the robot while the robot is in the autonomous traveling mode, switch the robot to the stop position reconfiguration mode.

In an example embodiment, the mode switching module may be configured to switch the robot to the stop position reconfiguration mode when the robot deviates from the stop position by an external force a predetermined number of times or more or for a predetermined period of time or more after moving to the stop position.

In an example embodiment, the robot control system may switch the robot to the stop position reconfiguration mode when the robot detects an obstacle that prevents movement while moving to the stop position in the autonomous traveling mode.

In an example embodiment, the robot may be a serving robot for transporting food and beverage containers in a restaurant.

According to other aspects, there is provided a wireless call device for calling a robot equipped with the robot control system including a call button; and a call module configured to transmit a call command including identification information corresponding to the wireless call device to the robot when the call button is pressed to control the robot to move to a stop position corresponding to the identification information.

In an example embodiment, the call module may be configured to transmit the call command to the robot when the call button is pressed a plurality of times long or short and a predetermined pattern is formed by a length of each press or a length of a time interval between presses.

According to other aspects, there is provided a wireless call device for calling a robot equipped with the robot control system including a tag reader configured to recognize a tag located outside the wireless call device; and a call module configured to, when a tag is recognized by the tag reader, transmit a call command including identification information corresponding to the recognized tag to the robot to control the robot to move to a stop position corresponding to the identification information.

According to other aspects, there is provided a robot control method performed by a robot control system installed in a robot which controls the robot including controlling the robot to move along a preconfigured autonomous traveling path in an autonomous traveling mode; switching the robot from the autonomous traveling mode to a movement path reconfiguration mode when a predetermined switching condition is satisfied while the robot is in the autonomous traveling mode; and when the robot is moved by an external force in the movement path reconfiguration mode, tracking a movement path while the robot is moved by the external force, and reconfiguring the autonomous traveling path based on the tracked movement path.

In an example embodiment, the switching of the robot from the autonomous traveling mode to the movement path reconfiguration mode when the predetermined switching condition is satisfied while the robot is in the autonomous traveling mode may include switching the robot to the movement path reconfiguration mode when a movement path reconfiguration command is input through a predetermined input device installed in the robot while the robot is in the autonomous traveling mode.

In an example embodiment, the switching of the robot from the autonomous traveling mode to the movement path reconfiguration mode when the predetermined switching condition is satisfied while the robot is in the autonomous traveling mode may include switching the robot to the movement path reconfiguration mode when the robot detects an obstacle that prevents movement while moving along the autonomous traveling path in the autonomous traveling mode.

In an example embodiment, the switching of the robot from the autonomous traveling mode to the movement path reconfiguration mode when the predetermined switching condition is satisfied while the robot is in the autonomous traveling mode may include switching the robot to the movement path reconfiguration mode when the robot deviates from the autonomous traveling path by an external force a predetermined number of times or more or for a predetermined period of time or more while the robot is in the autonomous traveling mode.

According to other aspects, there is provided a robot control method performed by a robot control system installed in a robot which controls the robot, including controlling the robot to move to a preconfigured stop position when the robot is called in an autonomous traveling mode; switching the robot from the autonomous traveling mode to a stop position reconfiguration mode when a predetermined switching condition is satisfied while the robot is in the autonomous traveling mode; and when the robot is moved by an external force in the stop position reconfiguration mode, determining a movement position to which the robot is moved by an external force and reconfiguring the stop position to the movement position. According to another aspect, there is provided a computer program installed in a data processing apparatus and stored in a non-transitory recording medium to perform the method.

According to other aspects, there is provided a non-transitory computer-readable recording medium in which a computer program for performing the method.

According to an example embodiment of the present disclosure, it is possible to simply and easily change the movement path or stop position of the serving robot in the store, and to easily call the serving robot if necessary in addition to serving food, thereby greatly improving the user's convenience.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a diagram illustrating a schematic configuration of a robot on which a robot control system according to an example embodiment is mounted.

FIG. 2 is a diagram illustrating a relationship between a robot and a wireless call device according to an example embodiment.

FIG. 3 is a block diagram illustrating a schematic configuration of a robot control system according to an example embodiment.

FIG. 4A is a diagram illustrating a preconfigured path along which a robot autonomously travels in a store equipped with a plurality of tables/chairs.

FIG. 4B is a diagram illustrating a case in which arrangement of tables/chairs in a store is changed and it is impossible to move to a part of the existing autonomous traveling path.

FIG. 4C is a diagram illustrating a path along which a robot is moved by an external force.

FIG. 4D is a diagram illustrating an example in which an autonomous traveling path is reconfigured.

FIG. 5 is a diagram illustrating a process of reconfiguring a stop position of a robot.

FIG. 6 is a flowchart illustrating a robot control method according to an example embodiment.

FIGS. 7A and 7B are diagrams, each of which illustrates an example of a wireless call device according to an example embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are illustrated in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the present disclosure will be described in detail focusing on example embodiments with reference to the accompanying drawings. Like reference numerals in each drawing refer to like components.

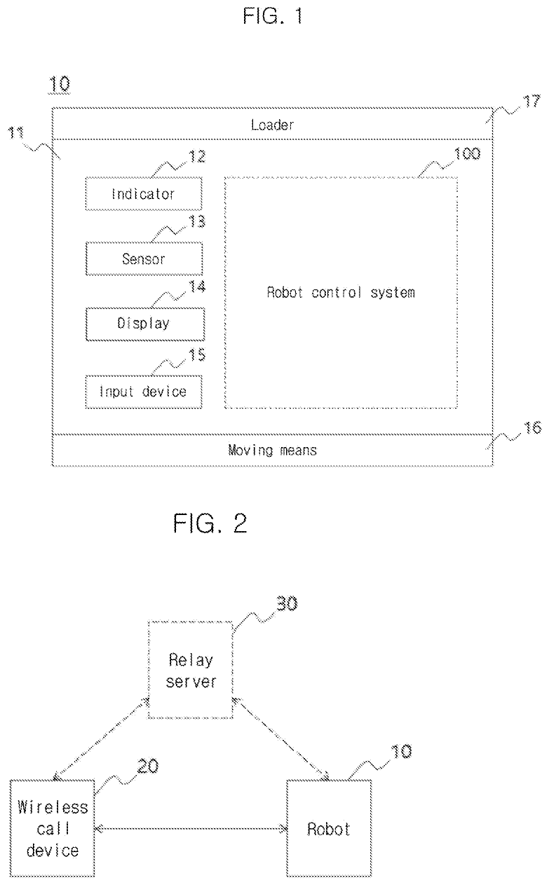

FIG. 1 is a diagram illustrating a schematic configuration of a robot on which a robot control system according to an example embodiment is mounted, and FIG. 2 is a diagram illustrating a relationship between the robot and a wireless call device according to an example embodiment.

The robot may be a serving robot configured to transport food and beverage containers in a restaurant. The following description assumes that the robot is a serving robot, but the robot to which a robot control system or a robot control method according to the technical idea of the present disclosure is applied is not limited to the serving robot. The technical idea of the present disclosure as described below may be applied to various robots operated in various fields.

First, referring to FIG. 1, a robot 10 may include a robot control system 100, a housing 11, an indicator 12, a sensor 13, a display 14, an input device 15, a moving means 16, and a loader 17.

The robot control system 100 performs the robot control method according to the technical idea of the present disclosure to control the robot 10 to change an autonomous traveling path, a stop position, and the like, of the robot 10 or to move the robot 10 to a calling place in response to a command of calling the robot.

The housing 11 forms a body of the robot 11 with a material such as metal, synthetic resin, and/or glass, and may protect a structure located inside the robot 10. The robot control system 100 may be installed inside the housing 11.

The indicator 12 may output information indicating a state (mode) of the robot 10. The robot 10 may be switched to various modes such as an autonomous traveling mode in which the robot 10 autonomously travels along a preconfigured autonomous traveling path and when there is a call, autonomously moves to a stop position corresponding to the call, a movement path reconfiguration mode in which the autonomous traveling path is reconfigured, a stop position reconfiguration mode in which the stop position is reconfigured, and a standby mode in which the robot 10 is stopped at a predetermined standby position in a standby state, and the indicator 12 may output information indicating a current mode of the robot 10. For example, the indicator 12 may be an LED indicator that outputs various colors according to the modes of the robot 12. Alternatively, the indicator 12 may be a device configured to display information for identifying the mode of the robot.

The sensor 13 may sense a specific physical quantity or a specific type of energy. For example, the sensor 13 may include a position detection sensor that detects a current position of the robot 10, a motion state detection that detects a motion state (e.g., speed, acceleration, posture, etc.) of the robot 10, an external force detection sensor that detects an external force applied to the robot 10, an image sensor that receives an optical signal and converts it into an electrical signal, and a weight detection sensor that detects a weight of a load loaded in the loader 17 as well as at least some of an illuminance sensor, a proximity sensor, a pressure sensor, an optical sensor, a magnetic sensor, an acceleration sensor, and a gyro sensor.

The display 14 may be a device configured to visually output information to be output by the robot control system 100 to the outside. The display 14 may include a liquid crystal display (LCD), a light emitting diode display (LED), a plasma display (PDP), an organic light emitting diode display (OLED), and a surface conduction electron emission display (SED).

The input device 15 is a device capable of receiving a user's input, and may include a touch panel, a keyboard, and a keypad. The touch panel may include a pressure-sensitive touch panel, a resistive touch panel, or a capacitive touch panel, and may be in the form of a touch screen combined with the display device 14.

The moving means 16 is a means configured to impart mobility to the robot 10, and may include a wheel driven by a motor for rotational motion and a leg-shaped walking means capable of walking.

The loader 17 is a means configured to load objects such as dishes, and may include a tray.

Referring to FIG. 2, the robot 10 may receive a call command from a wireless call device 20, and the robot 10 called by the wireless call device 20 may respond to the call command to move to a predetermined stop position. If the technical idea of the inventive concepts is applied to the serving robot operated in the restaurant, the wireless call device 20 may be attached to each table in the store, and serving robot receiving the call command according to operation of the wireless call device 20 may move to a stop position near the corresponding table.

In one example embodiment, the robot 10 and the wireless call device 20 are connected to each other through wireless communication to transmit and receive various information, signals, data, and the like used to implement the technical idea of the inventive concepts. The robot and the wireless calling device 20 may communicate by a long-distance wireless communication method such as 3G, LTE, LTE-A, Wi-Fi, WiGig, or Ultra Wide Band (UWB), or by a short-range wireless communication method such as MST, Bluetooth, NFC, RFID, ZigBee, Z-Wave, or IR.

In another example embodiment, the robot 10 and the wireless call device 20 may communicate with each other via a predetermined relay server 30. In this case, the robot 10 and the relay server 30, and the wireless call device 20 and the relay server 30 may communicate using the above-described wireless communication method.

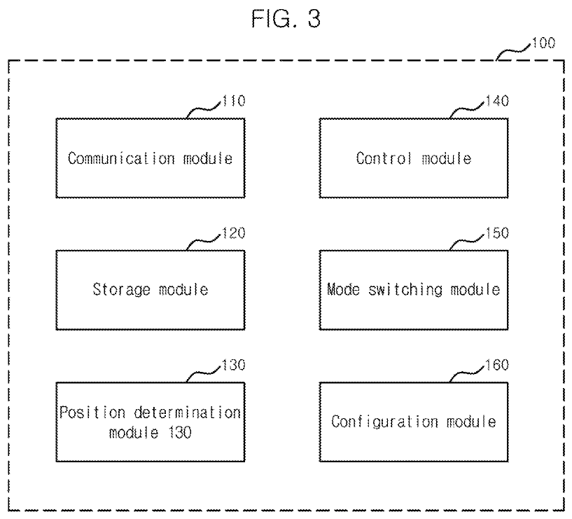

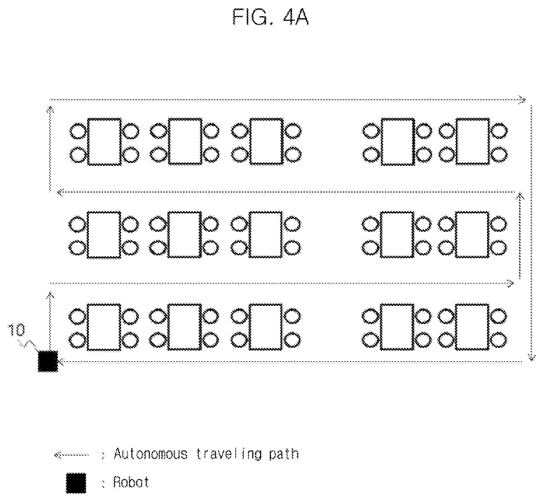

FIG. 3 is a block diagram illustrating a schematic configuration of the robot control system 100 according to an example embodiment.

Referring to FIG. 3, the robot control system 100 includes a communication module 110, a storage module 120, a position determination module 130, a control module 140, a mode switching module 150, and a configuration module 160. According to an example embodiment, some of the above-described components may not necessarily correspond to components essential for implementation of the inventive concepts. Of course, according to an example embodiment, the robot control system 100 may include more components.

The robot control system 100 may include hardware resources and/or software used to implement the technical idea of the inventive concepts, and does not necessarily mean a single physical component or a single device. In other words, the robot control system 100 may mean a logical combination of hardware and/or software provided to implement the technical idea of the inventive concepts. The robot control system 100 may, if desired, be implemented as a set of logical configurations configured to implement the technical idea of the inventive concepts installed in devices spaced apart from each other to perform respective functions. In addition, the robot control system 100 may mean a set of components separately implemented for each function or role for implementing the technical idea of the inventive concepts.

In addition, in the present specification, a module may mean a functional and structural combination of hardware configured to carry out the technical idea of the inventive concepts and software configured to drive the hardware. For example, it may be easily inferred by an average expert in the art of the inventive concepts that the module may mean a logical unit of a predetermined code and a hardware resource configured to execute the predetermined code, and does not necessarily mean physically connected codes or one type of hardware.

The control module 140 control functions and/or resources of the robot control system 100 and other components included in the robot 10 (e.g., the communication module 110, the storage module 120, the position determination module 130, the mode switching module 150, and the configuration module 160).

The communication module 110 may communicate with an external device and transmit/receive various signals, information, and data. The communication module 110 is a 3G module, an LTE module, an LTE-A module, a Wi-Fi module, a WiGig module, an Ultra Wide Band (UWB) module, a long-distance communication module such as a LAN card or an MST module, a Bluetooth module, an NFC module, an RFID module, a ZigBee module, a Z-Wave module, and a short-range communication module such as an IR module.

The storage module 120 may store various data and computer programs, such as data received/input from an external device and data generated by the robot control system 100. The storage module 120 may include a volatile memory and a non-volatile memory. The storage module 120 may include, for example, an SSD, a flash memory, a ROM, a RAM, an EEROM, an EPROM, an EEPROM, a hard disk, and a register. Alternatively, the storage module 120 may include a file system, a database, and an embedded database.

The storage module 120 may store in advance information on a path along which the robot 10 is to autonomously travel in the autonomous traveling mode, in other words, the autonomous traveling path, and information about a destination to which the robot 10 should move, when the robot 10 is called, in response to the call, in other words, the stop position.

The position determination module 130 may determine the position of the robot 10. The position determination module 130 may determine the position of the robot 10 based on various signals detected by the sensor 13 installed in the robot 10. For example, the position determination module 130 may determine the position of the robot 10 through GPS (Global Positioning System) information or IPS (Indoor Positioning System) information, or detect a motion of the robot 10 by a speed sensor, an acceleration sensor, a gyro sensor, or the like included in the sensor 13 to determine the position of the robot 10 based thereon. In addition to this, the position determination module 130 may determine the position of the robot 10 through various known methods.

Further, the position determination module 130 may periodically determine the position of the robot 10 for a predetermined period, thereby tracking a movement path along which the robot moves during the predetermined period.

The control module 140 may control the robot 10 to move along the preconfigured autonomous traveling path in the autonomous traveling mode.

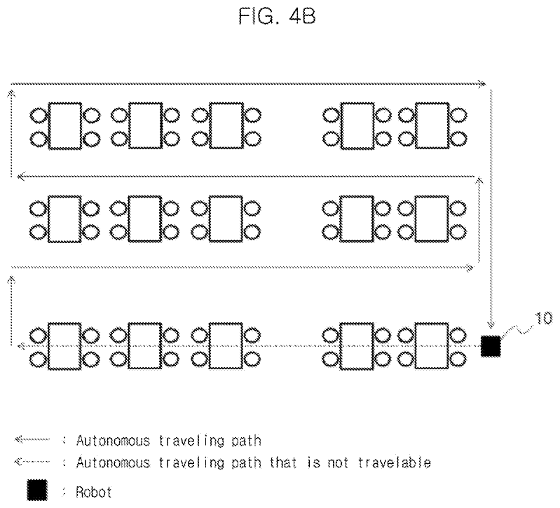

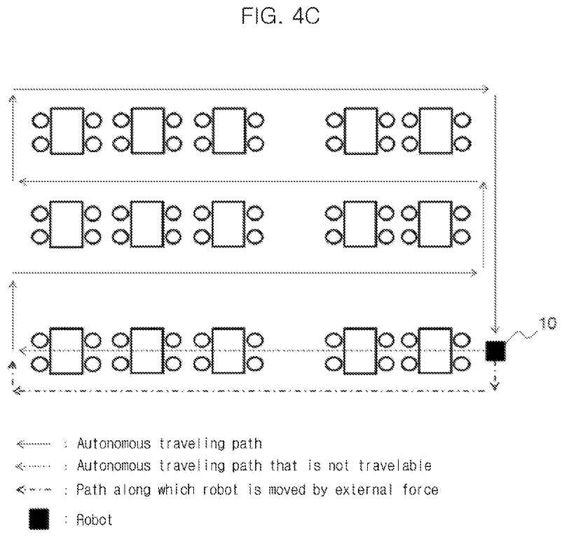

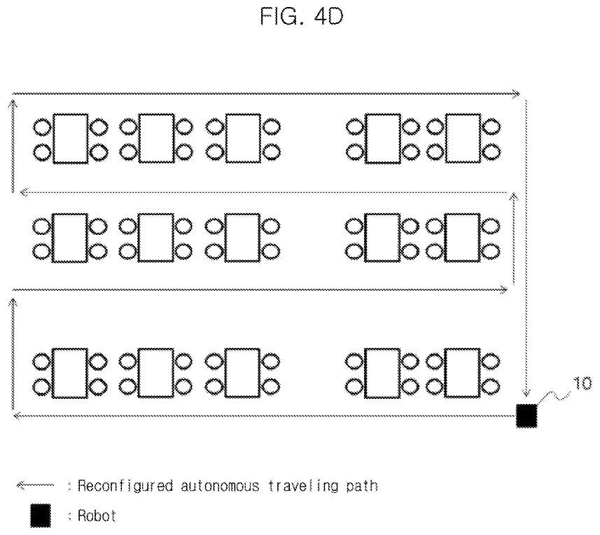

FIG. 4A is a diagram illustrating a preconfigured path along which the robot 10 autonomously travels in a store equipped with a plurality of tables/chairs (i.e., the preconfigured autonomous traveling path). Referring to FIG. 4, in the autonomous traveling mode, the control module 140 may control the robot 10 to move along the autonomous traveling path indicated by arrows.

Information on the autonomous traveling path may be predefined and stored in the storage module 120. In an example embodiment, the information on the autonomous traveling path may be configured as coordinates for a plurality of intermediate points on the autonomous traveling path.

Although FIG. 4A illustrates an example in which the autonomous traveling path circulates one path, the autonomous traveling path may be in the form of reciprocating between two points separated from each other, and may be configured in the form in which a plurality of movement paths are combined. In the case of the form in which the plurality of movement paths are combined, the control module 140 may select one of the movement paths and control the robot 10 to autonomously travel along the selected movement path.

Referring back to FIG. 3, the mode switching module 150 may switch the robot from the autonomous traveling mode to the movement path reconfiguration mode when a predetermined movement path switching condition is satisfied while the robot 10 is in the autonomous traveling mode.

In one example embodiment, the mode switching module 150 may switch the robot 10 to the movement path reconfiguration mode when the robot detects an obstacle that prevents movement while moving along the autonomous traveling path in the autonomous traveling mode.

This will be described with reference to FIG. 4B as an example. When arrangement of the tables installed in the store is changed from that illustrated in FIG. 4A to that illustrated in FIG. 4B, the robot 10 autonomously traveling is blocked by the tables as illustrated in FIG. 4B and may no longer move along the autonomous traveling path. The mode switching module 150 may switch the robot 10 to the movement path reconfiguration mode. In other words, when the robot 10 collides with an obstacle while moving along the autonomous traveling path or is unable to move due to the obstacle in a situation where the previously configured autonomous traveling path is blocked due to a change in the location of an object installed in the store, the mode switching module 150 may detect this and switch the robot 10 to the movement path reconfiguration mode.

In addition, movement path switching conditions configured to switch the robot 10 from the autonomous traveling mode to the movement path reconfiguration mode may vary.

In another example embodiment, when the mode switching module 150 receives a movement path reconfiguration command through the predetermined input device 15 installed in the robot 10 while the robot is in the autonomous traveling mode, the mode switching module 150 may switch the robot to the movement path reconfiguration mode. In other words, when the user (e.g., a store employee) determines that it is desired to change the autonomous traveling path, the user may select a movement path reconfiguration menu or the like through the input device 15 of the robot 10 to input the movement path reconfiguration command, and in response to this, the mode switching module 150 may switch to the movement path reconfiguration mode.

Alternatively, in another example embodiment, when the robot 10 deviates from the autonomous traveling path by an external force a predetermined number of times or more or for a predetermined period of time or more while being in the autonomous traveling mode, the mode switching module 150 may switch the robot 10 to the movement path reconfiguration mode. More specifically, when the user applies the external force to the robot in the autonomous traveling mode to push or pull the robot, the mode switching module 150 may detect this. For example, when detecting the external force through the sensor 13 provided in the robot 10 or that the position of the robot 10 is changed in a situation where the robot 10 is not controlled by the control module 140 or deviates from the preconfigured autonomous traveling path, the mode conversion module 150 may determines that the robot 10 deviates from the autonomous traveling path due to the external force. When it is determined that the robot 10 deviates from the autonomous traveling path by the external force the predetermined number of times or more or for the predetermined period of time or more, the mode switching module 150 may switch the robot 10 to the movement path reconfiguration mode.

Alternatively, when the robot deviates from the autonomous traveling path by the external force a predetermined number of times or more or for a predetermined period of time or more after the robot detects an obstacle that prevents movement while moving along the autonomous traveling path in the autonomous traveling mode, the mode switching module 150 may switch the robot 10 to the movement path reconfiguration mode.

Alternatively, when detecting the situation where the obstacle that prevents movement is detected while the robot moves along the autonomous traveling path in the autonomous traveling mode and/or the robot deviates from the autonomous traveling path by the external force the predetermined number of times or more or for the predetermined period of time or more, the mode switching module 150 may output alarm information informing the user of the situation and may receive the user's movement path reconfiguration command to switch the robot 10 to the movement path reconfiguration mode.

Further, referring back to FIG. 3, when the robot 10 is moved by the external force, the configuration module 160 may track the movement path while the robot 10 is moved by the external force in the movement path reconfiguration mode. In addition, the configuration module 160 may reconfigure the autonomous traveling path based on the tracked movement path.

An example in which the autonomous traveling path is reconfigured will be described with reference to FIGS. 4C and 4D.

Referring to FIG. 4C, the user may move the robot 10 by the external force by pushing or pulling the robot 10 switched to the movement path reconfiguration mode. As illustrated in FIG. 4C, the user may move the robot 10 along a path illustrated by the dashed-dotted line. Then, the configuration module 150 may track the movement path while the robot 10 is moved by the external force.

Thereafter, the configuration module 160 may reconfigure the autonomous traveling path based on the tracked movement path. The reconfigured movement path is illustrated in FIG. 4D. When the movement path caused by the external force such as the dashed-dotted line in FIG. 4C is tracked, the configuration module 160 may reflect this to the previously configured autonomous traveling path and reconfigure the autonomous traveling path as illustrated in FIG. 4D.

On the other hand, the mode switching module 150 may switch the robot 10 to the autonomous traveling mode after the autonomous traveling path is reconfigured by the configuration module 160, and the control module 140 may control the robot 10 to autonomously travel along the reconfigured autonomous traveling path.

As described above, the robot control system 100 according to an example embodiment may change the autonomous traveling path of the robot 10. In addition, the robot control system 100 according to another example embodiment may change the preconfigured stop position of the robot 10, which will be described below.

The robot 10 may be called by the wireless call device 20 in the autonomous traveling mode, and the control module 120 may control the robot 10 to move to the preconfigured stop position when the robot 10 is called.

The mode switching module 150 may switch the robot 10 from the autonomous traveling mode to the stop position reconfiguration mode when a predetermined stop position switching condition is satisfied while the robot 10 is in the autonomous traveling mode.

In one example embodiment, the mode switching module 150 may switch the robot to the stop position reconfiguration mode when a stop position reconfiguration command is input through the predetermined input device 15 installed in the robot while the robot 10 is in the autonomous traveling mode. In other words, when the user (e.g., the store employee) determines that it is desired to change the stop position, the user selects a device position reconfiguration menu or the like through the input device 15 of the robot 10 to input the stop position reconfiguration command, and in response to this, the mode switching module 150 may switch the robot 10 to the stop position reconfiguration mode.

In another example embodiment, when the robot 10 deviates from the stop position by an external force a predetermined number of times or more or for a predetermined period of time or more after the robot 10 moves to the stop position, the mode switching module 150 may switch the robot 10 to the stop position reconfiguration mode. More specifically, when the user applies the external force to the robot moved to the stop position by the call to push or pull it, the mode switching module 150 may detect this. For example, when detecting the external force through the sensor 13 provided in the robot 10 or that the position of the robot 10 is changed in a situation where the robot 10 is not controlled by the control module 140 or deviates from the stop position, the mode conversion module 150 may determines that the robot 10 deviates from the stop position due to the external force. When it is determined that the robot 10 deviates from the stop position by the external force the predetermined number of times or more or for the predetermined period of time or more, the mode switching module 150 may switch the robot 10 to the stop position reconfiguration mode.

In another example embodiment, when the robot detects an obstacle that prevents movement while moving to the stop position in the autonomous traveling mode, the robot may be switched to the stop position reconfiguration mode.

In another example embodiment, when the robot 10 detects an obstacle that prevents movement while moving to the stop position by the call of the wireless call device 20 in the autonomous traveling mode, the robot may be moved to the stop position reconfiguration mode. In other words, when the robot 10 collides with the obstacle while moving along a path to the stop position or is unable to move due to the obstacle in a situation where the path to the previously configured stop position is blocked due to a change in the location of an object installed in the store, the mode switching module 150 may detect this and switch the robot 10 to the stop position reconfiguration mode.

Further, when the robot 10 is moved by the external force in the stop position reconfiguration mode, the configuration module 160 may determine a movement position to which the robot 10 is moved by the external force, and reconfigure the stop position to the movement position.

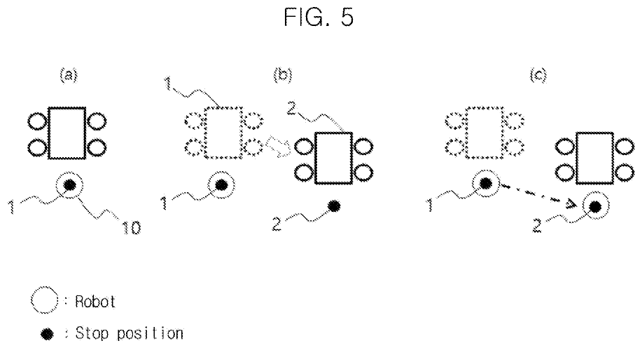

An example in which the stop position of the robot 10 is reconfigured will be described with reference to FIG. 5.

FIG. 5(a) is a diagram illustrating the robot 10 that moves to a preconfigured previous stop position. Before the stop position is reconfigured, the robot 10 may move to a stop position 1 preconfigured by calling of the wireless call device 20.

FIG. 5(b) is a diagram illustrating that the stop position should be changed as tables/chairs arrangement near the stop position is changed. In the case that the tables/chairs has been previously placed in position (1) and the arrangement is changed to position (2), the robot 10 should arrive at the stop position (2) when the robot 10 is called, but the robot 10 moves to the preconfigured stop position (1).

At this time, when the above-described stop position switching condition is satisfied, the robot 10 is switched to the stop position switching mode, the user changes the position of the robot from the position (1) to the position (2) by an external force as illustrated in FIG. 5(c), and the configuration module 160 may reconfigure the stop position from the position (1) to the position (2).

After the stop position is reconfigured by the configuration module 160, the mode switching module 150 may switch the robot 10 to the autonomous traveling mode. In the case that there is a call from the wireless call device 20 after the stop position is reconfigured, the control module 150 may move the robot 10 to the position (2) instead of the position (1).

In addition, the control module 140 may control the robot to move along the autonomous traveling path again when a predetermined stop period of time elapses after the robot is called and moves to the stop position. In the case that the robot 10 is required to stay a little longer at the stop position, the control module 140 may extend the stop period of time and control the robot 10 to move along the autonomous traveling path again after the extended period of time elapses. In particular, when the robot 10 is the serving robot, it is desired to load the serving robot with dishes to be removed from the table. Accordingly, the control module 140 may extend the stop period of time when it is detected that the robot 10 is loaded with an object.

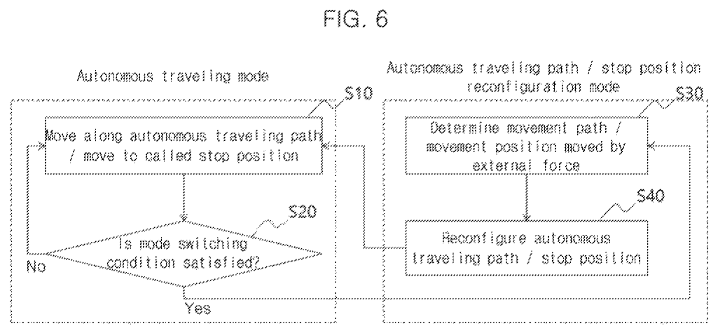

FIG. 6 is a flowchart illustrating a robot control method according to an example embodiment.

Referring to FIG. 6, the robot 10 may be in the autonomous traveling mode or the autonomous traveling path (or the stop position reconfiguration mode).

When the robot 10 is in the autonomous traveling mode, the robot control system 100 may control the robot 10 to move along the preconfigured autonomous traveling path or move to the preconfigured stop position by calling of the wireless call device 20 (S10).

Further, the robot control system 100 may determine whether a predetermined autonomous traveling path reconfiguration mode switching condition (or a stop position reconfiguration mode switching condition) is satisfied (S20). When it is determined that the condition is satisfied, the robot control system 100 may switch to the movement path reconfiguration mode (or the stop position reconfiguration mode).

In the movement path reconfiguration mode (or the stop position reconfiguration mode), the robot control system 100 may determine the movement path of the robot moved by an external force (or the movement position of the robot moved by the external force) (S30), and may reconfigure the autonomous traveling path (or the stop position) (S40). When the reconfiguration is completed, the robot control system 100 may switch the robot 10 back to the autonomous traveling mode.

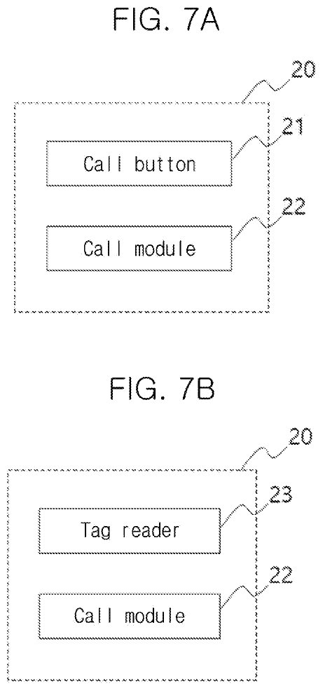

Each of FIGS. 7A and 7B is a diagram illustrating an example of a wireless call device according to an example embodiment.

First, referring to FIG. 7A, in one example embodiment, the wireless call device 20 may include a call button 21 and a call module 22.

The call button 21 is a button that receives the user's input, and may be a physical button or a virtual button implemented as a touch screen provided in the wireless call device 20.

When the call button 21 is pressed, the call module 22 may transmit a call command including identification information corresponding to the wireless call device 20 to the robot 10, and control the robot 10 to move to the stop position corresponding to the identification information.

The store may be equipped with a plurality of the wireless call devices 20. For example, the wireless call device may be attached to each table arranged in the store. In this case, because the robot 10 should move to the stop position near the table where the wireless call device that calls it is installed, the stop position corresponding to each wireless call device may be preconfigured. In particular, the identification information of each wireless call device and the stop position corresponding to the wireless call device may be mapped. Further, when there is a call from the wireless call device 20, the robot 10 may move to the stop position corresponding to the wireless call device 20 that calls it among several preconfigured stop positions.

The call button 21 may be pressed short or long, and a pattern such as a Morse code may be formed by the length of each pressing. The call module 22 may recognize a Morse code-like pattern formed by a button press or a time interval between presses, and transmit the call command to the robot 10 only when the pattern matches a predefined pattern. In other words, in one example embodiment, when the call button 21 is pressed long or short multiple times and a predetermined pattern is formed by the length of each press or the length of the time interval between presses, the call module 22 may transmit the call command to the robot 10. In this way, it is possible to prevent a customer seated at the table in the store from arbitrarily calling the robot 10, and allow only the employee who knows the predetermined pattern to call the robot 10.

Referring to FIG. 7B, the wireless call device 20 may include a tag reader 23 and the call module 22.

The tag reader 23 may recognize a tag located outside of the wireless call device 20. The tag may be attached to a fixed location such as the table in the store, and the tag reader 23 may recognize identification information corresponding to the tag. The tag may include an NFC tag, a barcode tag, and a QR code tag.

When the tag is recognized by the tag reader 23, the call module 22 may transmit a call command including the identification information corresponding to the recognized tag to the robot 10 to control the robot 10 to move to the stop position corresponding to the identification information.

The example embodiment illustrated in FIG. 7B may be used in a form in which the employee recognizes the tag attached to the table while carrying the wireless call device 20.

According to an example embodiment, the robot control system 100 may include a processor and a memory configured to store a program executed by the processor. The processor may include a CPU, GPU, MCU, APU, microprocessor, single-core CPU, or multi-core CPU. The memory may include high-speed random access memory and may include non-volatile memory such as one or more magnetic disk storage devices, flash memory devices, or other non-volatile solid-state memory devices. Access to the memory by the processor and other components may be controlled by a memory controller. Here, when the program is executed by the processor, the robot control system 100 according to the present example embodiment may perform the above-described method.

In addition, the method according to an example embodiment may be implemented in the form of computer-readable program instructions and stored in a non-transitory computer-readable recording medium, and a control program and a target program according to an example embodiment may also be stored in a non-transitory computer-readable recording medium. The non-transitory computer-readable recording medium includes all types of recording devices in which data readable by a computer system is stored.

The program instructions recorded on the recording medium may be specially designed and configured for the inventive concepts, or may be known and available to those skilled in the software field.

Examples of the non-transitory computer-readable recording medium include hardware devices specially configured to store and execute program instructions, such as magnetic media such as hard disks, floppy disks and magnetic tapes, optical recording media such as CD-ROMs and DVDs, magneto-optical media such as floptical disks, ROM, RAM, and flash memory. In addition, the non-transitory computer-readable recording medium is distributed in a computer system connected through a network, so that computer-readable codes may be stored and executed in a distributed manner.

Examples of the program instruction include not only machine codes such as generated by a compiler, but also high-level language codes that can be executed by a device configured to electronically process information using an interpreter or the like, for example, a computer.

The hardware devices described above may be configured to operate as one or more software modules to perform operations of the present disclosure, and vice versa.

The foregoing description of the present disclosure is for illustration, and those skilled in the art to which the present disclosure pertains can understand that modifications into other specific forms may be easily made without changing the technical spirit or essential features of the present disclosure. Therefore, it should be understood that the example embodiments described above are illustrative in all respects and not restrictive. For example, each component described as a single type may be implemented in a distributed manner, and components described as distributed may be implemented in a combined form.

The scope of the present disclosure is indicated by the appended claims rather than the above detailed description, and all changes or modifications derived from the meaning and scope of the claims and their equivalent concepts should be construed as being included in the scope of the present disclosure.

### INDUSTRIAL APPLICABILITY

The present disclosure may be applied to a robot control system, a robot control method, and a wireless call device.

Some of the advantages that may be achieved by implementations/embodiments of the invention and/or methods of the invention include***

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A robot control system installed in a robot to control the robot, comprising:
a control module configured to control the robot to move along a preconfigured autonomous traveling path in an autonomous traveling mode;
a mode switching module configured to switch the robot from the autonomous traveling mode to a movement path reconfiguration mode when a predetermined switching condition is satisfied while the robot is in the autonomous traveling mode; and
a configuration module configured to, when the robot is moved by an external force in the movement path reconfiguration mode, track a movement path while the robot is moved by the external force, and to reconfigure the autonomous traveling path based on the tracked movement path.

2. The robot control system of claim 1, wherein the mode switching module is configured to switch the robot to the movement path reconfiguration mode when a movement path reconfiguration command is input through a predetermined input device installed in the robot while the robot is in the autonomous traveling mode.

3. A robot control system of claim 1, wherein the mode switching module is configured to switch the robot to the movement path reconfiguration mode when the robot deviates from the autonomous traveling path by an external force a predetermined number of times or more or for a predetermined period of time or more while the robot is in the autonomous traveling mode.

4. The robot control system of claim 1, wherein the mode switching module is configured to switch the robot to the movement path reconfiguration mode when the robot detects an obstacle that prevents movement while moving along the autonomous traveling path in the autonomous traveling mode.

5. The robot control system of claim 1, wherein the control module is configured to control the robot to move to a preconfigured stop position when the robot is called in the autonomous traveling mode.

6. The robot control system of claim 5, wherein the control module is configured to control the robot to move along the autonomous traveling path when a predetermined stop period of time elapses after the robot moves to the stop position, and
extend the stop period of time when it is detected that the robot is loaded with an object.

7. A robot control system installed in a robot to control the robot, comprising:
a control module configured to control the robot to move to a preconfigured stop position when the robot is called in an autonomous traveling mode;
a mode switching module configured to switch the robot from the autonomous traveling mode to a stop position reconfiguration mode when a predetermined switching condition is satisfied while the robot is in the autonomous traveling mode; and
a configuration module configured to, when the robot is moved by an external force in the stop position reconfiguration mode, determine a movement position to which the robot is moved by an external force, and reconfigure the stop position to the movement position.

8. The robot control system of claim 7, wherein the mode switching module is configured to, when a stop position reconfiguration command is input through a predetermined input device installed in the robot while the robot is in the autonomous traveling mode, switch the robot to the stop position reconfiguration mode.

9. The robot control system of claim 7, wherein the mode switching module is configured to switch the robot to the stop position reconfiguration mode when the robot deviates from the stop position by an external force a predetermined number of times or more or for a predetermined period of time or more after moving to the stop position.

10. The robot control system of claim 7, wherein the mode switching module is configured to switch the robot to the stop position reconfiguration mode when the robot detects an obstacle that prevents movement while moving to the stop position in the autonomous traveling mode.

11. The robot control system of claim 7, wherein the robot is a serving robot for transporting food and beverage containers in a restaurant.

12. A wireless call device configured to call a robot equipped with the robot control system according to claim 7, comprising:
a call button; and
a call module configured to transmit a call command including identification information corresponding to the wireless call device to the robot when the call button is pressed to control the robot to move to a stop position corresponding to the identification information.

13. The wireless call device of claim 12, wherein the call module is configured to transmit the call command to the robot when the call button is pressed a plurality of times long or short and a predetermined pattern is formed by a length of each press or a length of a time interval between presses.

14. A wireless call device configured to call a robot equipped with the robot control system according to claim 7, comprising:
a tag reader configured to recognize a tag located outside the wireless call device; and
a call module configured to, when a tag is recognized by the tag reader, transmit a call command including identification information corresponding to the recognized tag to the robot to control the robot to move to a stop position corresponding to the identification information.

15. A robot control method performed by a robot control system installed in a robot which controls the robot, comprising:
controlling the robot to move along a preconfigured autonomous traveling path in an autonomous traveling mode;
switching the robot from the autonomous traveling mode to a movement path reconfiguration mode when a predetermined switching condition is satisfied while the robot is in the autonomous traveling mode; and
when the robot is moved by an external force in the movement path reconfiguration mode, tracking a movement path while the robot is moved by the external force, and reconfiguring the autonomous traveling path based on the tracked movement path.

16. The robot control method of claim 15, wherein the switching of the robot from the autonomous traveling mode to the movement path reconfiguration mode when the predetermined switching condition is satisfied while the robot is in the autonomous traveling mode comprises switching the robot to the movement path reconfiguration mode when a movement path reconfiguration command is input through a predetermined input device installed in the robot while the robot is in the autonomous traveling mode.

17. The robot control method of claim 15, wherein the switching of the robot from the autonomous traveling mode to the movement path reconfiguration mode when the predetermined switching condition is satisfied while the robot is in the autonomous traveling mode comprises switching the robot to the movement path reconfiguration mode when the robot detects an obstacle that prevents movement while moving along the autonomous traveling path in the autonomous traveling mode.

18. The robot control method of claim 15, wherein the switching of the robot from the autonomous traveling mode to the movement path reconfiguration mode when the predetermined switching condition is satisfied while the robot is in the autonomous traveling mode comprises switching the robot to the movement path reconfiguration mode when the robot deviates from the autonomous traveling path by an external force a predetermined number of times or more or for a predetermined period of time or more while the robot is in the autonomous traveling mode.

19. A robot control method performed by a robot control system installed in a robot which controls the robot, comprising:
controlling the robot to move to a preconfigured stop position when the robot is called in an autonomous traveling mode;
switching the robot from the autonomous traveling mode to a stop position reconfiguration mode when a predetermined switching condition is satisfied while the robot is in the autonomous traveling mode; and
when the robot is moved by an external force in the stop position reconfiguration mode, determining a movement position to which the robot is moved by an external force and reconfiguring the stop position to the movement position.

20. A computer program installed in a data processing apparatus and stored in a non-transitory recording medium to perform the method according to claim 19.

21. A non-transitory computer-readable recording medium in which a computer program for performing the method according claim 19 is recorded.
